(19) United States
(12) Patent Application Publication
(10) Pub. No.: US 2021/0158622 A1
(43) Pub. Date: May 27, 2021

(54) THREE DIMENSIONAL IMAGE DISPLAY IN AUGMENTED REALITY AND APPLICATION SETTING

(71) Applicant: Social Nation, Inc., Millbrae, CA (US)

(72) Inventors: Pairote Leelaphattarakij, Bangkok (TH); Vibhavee Trairattanapa, Bangkok (TH); Sarin Achawaranont, Bangkok (TH); Nawaporn Upariboon, Bangkok (TH); Michael Rucker, Redwood City, CA (US); Prachaya Phaisanwiphatpong, Millbrae, CA (US)

(21) Appl. No.: 16/698,642

(22) Filed: Nov. 27, 2019

(51) Int. Cl. G06T 19/00; G06T 19/20; G06T 7/579; H04N 13/128

(52) U.S. Cl. CPC G06T 19/006; H04N 13/128; G06T 7/579; G06T 19/20

(57) ABSTRACT

Systems and methods for receiving a 3D image, the 3D image comprising a plurality of pixels forming a first 3D object, receiving a request for displaying an augmented reality (AR) environment, and generating an AR environment on a display, the AR environment comprising, real time photo images received by an image capture device, one or more interactive 3D objects, including the first 3D object, overlayed on the photo images, wherein the one or more interactive 3D objects can be manipulated by a user engaging in with the AR environment.

### BACKGROUND

The following relates generally to depth map generation, and more specifically to automatically generating depth map images from two dimensional (2D) images.

Both two dimensional (2D) and 3D images are used in a wide variety of applications. In some cases, it is desirable to create a 3D image from a 2D image. For example, advertisers often use 2D images to create online advertising banners. This is because 2D technology is provided out-of-the-box by web browsers and does not require a special system to design and implement the ads. However, ad banners created using 2D images may not be as effective as 3D images at drawing attention. Furthermore, creating 3D images using existing techniques may be costly and time consuming. Therefore, it would be desirable for advertisers and other producers and consumers of images to efficiently generate 3D images.

### BRIEF SUMMARY

A computer-implemented method, apparatus, and non-transitory computer readable medium for displaying a three dimensional (3D) image are described. The computer-implemented method, apparatus, and non-transitory computer readable medium may provide for receiving a 3D image, the 3D image comprising a plurality of pixels forming a first 3D object, receiving a request for displaying an augmented reality (AR) environment, and generating an AR environment on a display, the AR environment comprising, real time photo images received by an image capture device, one or more interactive 3D objects, including the first 3D object, overlayed on the photo images, wherein the one or more interactive 3D objects can be manipulated by a user engaging in with the AR environment.

Further, the computer-implemented method, apparatus, and non-transitory computer readable medium may provide for receiving a banner configured to be displayed on a display device alongside the one or more 3D objects, wherein the banner comprises one or more lines of text, one or more logos, one or more two dimensional (2D) images, one or more 2D graphics, one or more 2D animations, a background image, or a combination thereof.

Further, the computer-implemented method, apparatus, and non-transitory computer readable medium may provide for detecting one or more 3D animation keyframes associated with the 3D image, and generating one or more interactive 3D animations based on the one or more 3D animation keyframes.

Further, the computer-implemented method, apparatus, and non-transitory computer readable medium may provide for receiving a plurality of 3D images, each comprising one or more 3D objects, and wherein 3D object may be an animated 3D object.

Further, the computer-implemented method, apparatus, and non-transitory computer readable medium may provide for creating a web tag, ad tag, third party tag, or third party ad serving (3PAS), associated with the 3D image.

Further, the computer-implemented method, apparatus, and non-transitory computer readable medium may provide for interaction with the one or more interactive 3D objects, wherein the one or more interactive 3D objects can be manipulated by rotating, scaling and rescaling, moving, orienting and reorienting, changing or swapping out a selected interactive 3D object from the one or more interactive 3D objects, changing a view or perspective of the one or more interactive 3D objects, or a combination thereof.

Further, the computer-implemented method, apparatus, and non-transitory computer readable medium may provide for the manipulating of the one or more interactive 3D objects, wherein the manipulation of the one or more interactive 3D objects can be performed by using a web page browser configured to display the AR environment, wherein the manipulation of the one or more interactive 3D objects on a web page browser can be performed by web page functions comprising scrolling gestures, click-and-drag gestures, mouse cursor movement, or a combination thereof.

Further, the computer-implemented method, apparatus, and non-transitory computer readable medium may provide for the manipulating of the one or more interactive 3D objects, wherein the manipulation of the one or more interactive 3D objects can be performed by using a web browser or mobile application on a mobile device, wherein the manipulation of the one or more interactive 3D objects on a web page browser or mobile application on a mobile device can be performed by moving, rotating, tilting, orienting, or a combination thereof, of the mobile device.

Further, the computer-implemented method, apparatus, and non-transitory computer readable medium may provide for the real time photo images of the AR environment including a real world physical environment such that the one or more interactive 3D objects are virtually projected onto the real world physical environment.

Further, the computer-implemented method, apparatus, and non-transitory computer readable medium may provide for the real time photo images of the AR environment including a self portrait environment of the user such that the one or more interactive 3D objects are virtually projected onto a physical member of the user.

Further, the computer-implemented method, apparatus, and non-transitory computer readable medium may provide for detecting a request for viewing a destination page and displaying the destination page on a web browser or mobile application.

Further, the computer-implemented method, apparatus, and non-transitory computer readable medium may provide for receiving a 3D image, the 3D image comprising a plurality of pixels forming a first 3D object, receiving a banner, overlaying the first 3D object onto the banner, wherein the first 3D object is an interactive 3D object.

Further, the computer-implemented method, apparatus, and non-transitory computer readable medium may provide for the interactive 3D object being selectable and rotatable, and detecting a selection of the interactive 3D object, and displaying a destination page based on the selection.

Further, the computer-implemented method, apparatus, and non-transitory computer readable medium may provide for the rotating of the interactive 3D object about a vertical axis, a horizontal axis, or a combination thereof.

Further, the computer-implemented method, apparatus, and non-transitory computer readable medium may provide for rotating the interactive 3D object automatically by a web browser application or mobile application upon detecting a user inactivity reaching a specified threshold.

### BRIEF DESCRIPTION OF THE DRAWINGS

The present disclosure will become better understood from the detailed description and the drawings, wherein:

FIG. 1 shows an example of an image generation system in accordance with aspects of the present disclosure.

FIG. 2 shows an example of an image generation module on a client device in accordance with aspects of the present disclosure

FIG. 3 shows an example of an online display advertising banner with 3D objects in accordance with aspects of the present disclosure.

FIGS. 4A-4C shows an example of an AR experience with a 3D object in accordance with aspects of the present disclosure.

FIG. 5 shows an example of an overview of a process for generating an AR environment in accordance with aspects of the present disclosure.

FIGS. 6A-6B shows an example of an overview of a process for displaying interactive 3D object on a banner in an AR environment in accordance with aspects of the present disclosure.

FIG. 7 shows an example of an overview of a process for displaying interactive 3D animations in an AR environment in accordance with aspects of the present disclosure.

FIG. 8 shows an example of an overview of a process for displaying and interacting with an interactive 3D banner in accordance with aspects of the present disclosure.

FIG. 9 shows an example of an overview of a process for displaying and interacting with an interactive 3D banner in an AR environment in accordance with aspects of the present disclosure.

FIG. 10 shows an example of an overview of a process for displaying the user manipulations of an interactive 3D object in an AR environment in accordance with aspects of the present disclosure.

### DETAILED DESCRIPTION

In this specification, reference is made in detail to specific examples of the description. Some of the examples or their aspects are illustrated in the drawings.

For clarity in explanation, the description has been described with reference to specific examples, however it should be understood that the description is not limited to the described examples. On the contrary, the description covers alternatives, modifications, and equivalents as may be included within its scope as defined by any patent claims. The following examples of the description are set forth without any loss of generality to, and without imposing limitations on, the claimed description. In the following description, specific details are set forth in order to provide a thorough understanding of the present description. The present description may be practiced without some or all of these specific details. In addition, well known features may not have been described in detail to avoid unnecessarily obscuring the description.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some examples are implemented by a computer system. A computer system may include a processor, a memory, and a non-transitory computer-readable medium. The memory and non-transitory medium may store instructions for performing methods and steps described herein.

The following relates generally to image generation, and more specifically to generating and displaying three dimensional (3D) images on a screen, webpage, application, or on an augmented reality (AR) application or environment.

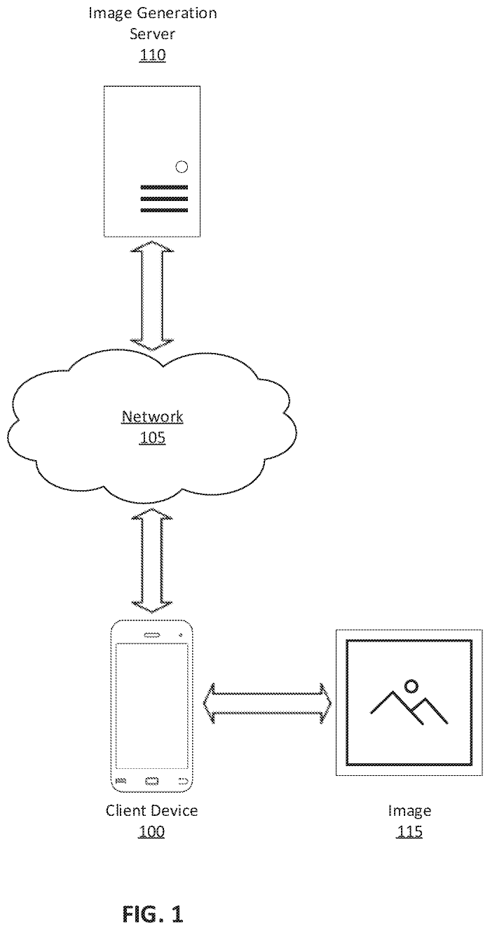

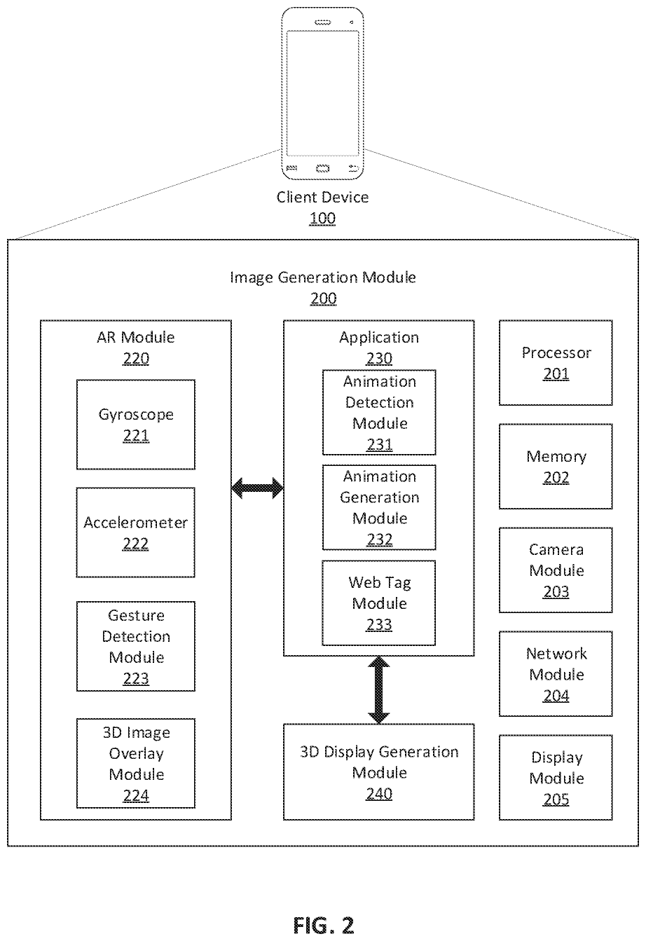

FIG. 1 shows an example of an 3D image generation, display and distribution system in accordance with aspects of the present disclosure. The example shown include client device 100, network 105, image generation server 110, and image 115. In one example, the client device 100 is used (e.g., by a person creating an advertising banner) to upload image 115 (e.g., 3D photo image or 3D object) to the image generation server 110 via the network 105. Client device 100 may be an example of, or include aspects of, the corresponding element or elements described with reference to FIG. 2.

In one example, the 3D image generation, display and distribution system takes one or more online banners, texts, logos, images, animations, interactive 3D objects, or a combination thereof, and generates an Augmented Reality (AR), Virtual Reality (VR) environment, or both, to display content to a user. The content may be generated in real-time on the image generation server 110, at the client device 100 or retrieved from previously generated content stored on the image generation server 110, client device 100, cloud storage devices, or a combination thereof.

In some examples, the image generation server 110 may collect and track metrics about the banners such as the amount of time that the user viewed the banner, the number of times or quality of the user's interaction with the banner, the amount of time that the user hovered over the banner, or a combination thereof

Examples of the 3D image generation, display and distribution system provide for the generation and displaying of banners that include interactive 3D objects, such as characters. The 3D objects may be animated and responsive to user gestures such as cursor movement, cursor clicks, movement of the client device 100, hand, body, head or eye movements of a user, as well as facial expressions. For example, the 3D image or images, banners, or both may be displayed on a website through an HTML5 compatible web browser, or on a mobile app operating on a smartphone.

In some examples, the 3D object may be a humanoid character, or anthropomorphic object/animal. The humanoid character, or anthropomorphic object or animal, or both may be animated in such a way as to mimic gestures, facial features, facial expressions, and emotions conveyed by the user and detected by the client device 100.

In one example, the 3D images and banners can be configured for 3D advertisement. 3D advertisement experiences grab audiences' attention effectively, which makes the advertisement messages and visual graphics stand out. 3D advertisements may also be clearly distinguishable from surrounding content, which results in more effective advertising.

The AR environment and the banners may be distributed via common web protocols and languages including hypertext markup language (HTML). In some examples, the system may be integrated with an existing advertisement building and editing software. For example, the image generation system workflow can be integrated as a plugin or custom template implementation. In some examples, an HTML output associated JavaScript renderer operates as a generic web component that can be used outside of an advertisement application (for example, embedded as a 3D photo on a website). Examples of the disclosure also provide for a 2D overlay feature. For example, additional 2D experiences can be overlaid on top of 3D images as part of the workflow described herein.

The AR environment disclosed, may allow a user to move around and navigate within an AR environment, interact with points of interest and objects, and view annotations or information related to objects or points of interest that are being focused on or selected. Selected objects or points of interest may link to 2D videos, slideshow, a 360 degree VR experience or another AR environment. The AR environment may allow for a user to manipulate the position, orientation or other properties and parameters of an object or point of interest. Points of interest may be added and annotated by the user while operating within the AR environment. The viewing angle of the environment, or objects, or both within the environment may be manipulated through gestures or based upon output from gyroscope 221, or accelerometer 222, or both.

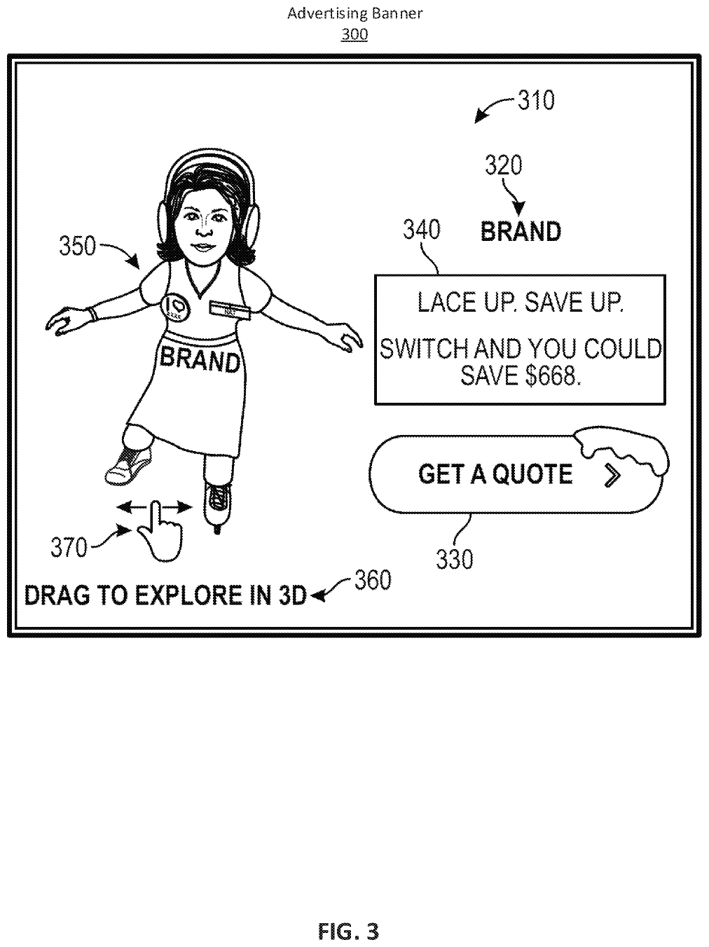

Banners, such as advertisement banners described in FIG. 3, may allow a user to interact with objects in a manner similar to that of interactions with AR environment objects as described above. Within the banner, objects may perform automatic or default animations when displayed on a mobile app or website. The animation can be halted upon scrolling away from the banner. Upon detection of inactivity of the user, one or more of the objects within the banner may be animated in such a way as to draw the attention of the user back to the banner. Examples of animations and other functions may include explosions, rapid movement, flashing, changes of color or patterns, waving of virtual characters arms, objects or characters mimicking emotions (e.g. sad, angry or disappointed) or audible sounds that would virtually emanate from the object, banner or products. Alternatively, upon detection of inactivity, the default animation of the object may be displayed.

In one example, the user scrolling a page up or scrolling a page down on the device may cause the 3D object in the banner to be zoomed in or zoomed out. In one example, the 3D object may be initialized in a zoomed out state and the 3D object may be below the user's current scroll position. As the user scrolls down to the banner, it zooms in to the 3D object. When the user scrolls past the banner, the 3D object zooms out as the user continues to scroll down. The scrolling may be on a mobile or desktop device.

In one example, the banner automatically pans up, down, left, and/or right even when there is no user input. This shows the user that the banner includes a 3D image and features and not just a flat banner.

In one example, as the user moves a cursor or other interaction point on the screen, the 3D image pans in that direction. For example, if the user moves the cursor or interaction point to the right, then the view of the 3D image pans to the right. Likewise, the same occurs for moving the cursor or interaction point to the left, up, or down.

The AR environment and banners may take the form of 360 degree video, adaptive 360 degree video streams, 360 degree photos, stereoscopic 360d degree video, 180 degree side-by-side 3D video or panoramic photos. The system may allow for a user to change the field of view of the camera, switch between different display modes and display/video formats.

In one example, the present disclosure discusses creating 3D images, including 3D advertisement experiences. 3D advertisement experiences grab audiences' attention effectively, which makes messages and visual graphics stand out. 3D images may also be clearly distinguishable from surrounding content, which results in more effective user activity and engagement.

FIG. 2 shows an example of an image generation module 200 on a client device in accordance with aspects of the present disclosure. Image generation module 200 may be an example of, or include aspects of, the corresponding element or elements described with reference to FIG. 1. In an example, image generation module 200 is a component or system on client device 100. In other examples, image generation module 200 comprises image generation server 110, or is a component or system on peripherals or third-party devices. Image generation module 200 may comprise hardware or software or both.

Image generation module 200 may include processor 201, memory 202, camera module 203, network module 204, display module 205, AR module 220, application 230, 3D display generation module 240 and.

A processor 201 may include an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor 201 may be configured to operate a memory array using a memory controller. In other cases, a memory controller may be integrated into processor 201. The processor 201 may be configured to execute computer-readable instructions stored in a memory to perform various functions related to generating 3D images.

Memory 202 may include random access memory (RAM), read-only memory (ROM), or a hard disk. The memory 202 may be solid state or a hard disk drive, and may store computer-readable, computer-executable software including instructions that, when executed, cause a processor to perform various functions described herein. In some cases, the memory 202 may contain, among other things, a BIOS which may control basic hardware or software operation such as the interaction with peripheral components or devices. In some cases, a memory controller may operate memory cells as described herein.

Camera module 203 may include any camera or combination of cameras configured to record images. The cameras may be any type of image sensor which provides an image of a scene viewed from the viewpoint of the device, or user, or both. The cameras may be any device configured to detect visible light (e.g. CCD or CMOS based cameras) or light of other spectrums (e.g. multi-spectral or hyper-spectral cameras), such as infrared, ultraviolet, x-rays or any other wavelength the device is capable of detecting. Other types of cameras are possible as well, such as a time-of-flight camera, stereoscopic cameras or other camera combinations capable of determining depth of a captured image/video. The camera module 203 may include hardware, or software, or both, to enable the use of structured light depth determination or time-of-flight depth determination. Camera module 203 may also be other types of range detectors, such as infrared sensors, LIDAR sensors or ultrasonic transceivers. Camera module 203 may also be a combination of two or more of the devices described above.

Network module 204 may transmit and receive network signals and receive signals from other computing systems via a network. In some examples, the network component 204 may enable transmitting and receiving signals from the Internet. signals received by the network component 204 may be used by the other modules. The modules may transmit signals through the network component 204.

Display module 205 may be a touch-screen display, a head-up display, a head-mounted display, an optical see-through display, an optical see-around display, a video see-through display, a flat-panel display, a light-emitting diode (LED) display, an electroluminescent display (ELD), an electrophoretic display (EPD or electronic paper), a liquid crystal display (LCD), an organic LED (OLED) display, an active-matrix organic light-emitting diode display or any other type of display on a display device.

AR module 220 may include gyroscope 221, accelerometer 222, gesture detection module 223 and 3D image overlay module 224. AR module 220 may generate an AR environment in which 3D virtual objects may be places with respect to physical real world objects and surfaces. For example, a user may select one or more preconfigured 3D virtual objects, or create one or more custom 3D virtual objects, and place said one or more 3D virtual objects into an AR environment. The placement can be in contact with a physical object or surface, such as placing the 3D virtual object on a wall or table. The 3D virtual object may take the form of furniture or other objects commonly used in interior design. The AR module 220 may allow a user to virtually design a room without the need to manually move or even purchase the furniture. AR module 220 overlays the virtual 3D objects through the use of a 3D image overlay module 224. The positioning, scale/size and orientation of the virtual 3D object within the environment is determined by a combination of inputs to the AR module 220 from gyroscope 221, accelerometer 222, gesture detection module 223 and camera module 203.

AR module 220 may map the dimensionality of the environment, including all physical objects inside the environment, in real time. A 3D model of the environment may be saved for later use. The modeling of the environment may also be generated by the image generation server 110 from images and positional signals provided by the client device 100 and then transferred to the client device 100.

Gyroscope 221 may be any device configured for measuring or maintaining orientation, based on the principles of conservation of angular momentum. Gyroscopes can be mechanical, electronic, or micro-electro-mechanical systems (MEMS), or a combination thereof, gyroscope devices. Gyroscope 221 may be a plurality of the above described device, as well as a combination of the above described devices. The gyroscope 221 may be used in combination with the accelerometer 222, the camera module 203, and other sensors to determine orientation, location, and pose of the client device 100, the user, and physical objects captured by the camera module 203. Gyroscope 221, along with accelerometer 222, may be used in the stabilization of images captured by the camera module 203. Gyroscope 221,

Accelerometer 222 may be any device capable of measuring the physical acceleration of the client device 100. Accelerometer may be an electronic device capable of detection acceleration of the device, converting the detected acceleration to an electrical signal, performing conversion from an analog signal to a digital signal, and providing the converted information to a processor, subsystem or module within the client device 100.

Gesture detection module 223 may receive as input, signals collected by any of the above described modules or devices. The gesture input collected may be related to a user interacting with an environment, the device or virtual objects.

In one example, gesture inputs may include, but are not limited to, hand, finger, body, head or eye movement that happen free from contact with the client device. Such gestures may include hand motions such as grabbing, pointing, waving, giving finger signs, and general motioning of a hand in directions. Hand gestures may be single hand gestures or multiple hand gestures and include movement of fingers and the user's arms. Gestures may also be derived from a user's body, head or eye movements as well as the above described hand gestures. A user may nod, rotate, sigh/exhale (chest movement), frown/smile, motion to a location with one's head, change the point of focus of one's eyes, or gaze at a point for a predetermined duration. Gesture detection module 223 may detect any of the above described gestures or combinations of those gestures as well as any other gesture or combination of gestures that can be determined by the analysis of detected movements.

Gesture inputs may also include, but are not limited to, movement of the client device 100, such as rotating, shaking, accelerating, or reorienting of the client device 100 in any way. The gestures may be combinations of movements, repetitions of movements, or durations of movements.

Gesture inputs may further include, but are not limited to, touch and multi-touch operations performed by a user on a touch screen device. Additionally, gestures may include swipe, tab, or flick, as well as other forms of contact, or movement, or both, of the contacted points may be detected.

Gesture detection module 223 may also capture real-time video from a back facing camera of a client device 100 while simultaneously capturing video with a front facing camera of the client device 100 of hand gestures performed by a user in free space in front of the device.

Gesture detection module 223 may also recognize compound gestures such as detecting gestures by both cameras at the same time and start a gesture in the view of one camera and complete the gesture in the view of the second camera. These compound gestures may also include a detecting a combination of any of the above described gestures through multiple sensor, devices or modules, simultaneously and in real-time.

3D image overlay module 224 may determine how the 3D virtual object is to be places and rendered at the positioning, scale/size and orientation specified with relation to the 3D model of the environment. 3D image overlay model 224 may determine the shape or appearance, including texture and color, of the virtual 3D object that is to be placed at the specified location. For example, in the case of furniture, the 3D image overlay module may adjust the type, model, material, color, or accessories of a piece of furniture. Different models and types of furniture may have different dimensions, as well as different material, color and accessory options. 3D image overlay module may generate the specific 3D virtual object based on these or other parameters associated with the virtual object, and render it in the appropriate location within the 3D environment.

3D image overlay module 224 may alternatively used to place objects on a person's head, face, hands or nails. Virtual 3D objects, such as hats, jewelry, glasses, clothing, or decorations may be oriented and applied to an image of the user. For example, a virtual try on environment may be created, where a user's choice of clothing may be overlaid on the appropriate part of their body to show how a piece of clothing will look. The 3D image overlay module 224 may also apply texture overlays to a person's face or nails to show how a selected makeup color or nail polish will look.

Application 230 may include animation detection module 231, animation generation module 232 and web tag module 233.

Animation detection module 231 may determine one or more animations that are to be associated with a 3D virtual object. The one or more animations may be dependent up user interaction, inactivity, time of day, location of the user, or any combination of influencing parameters. The animation detection module 231 may determine the nature of the animations, such as whether the animations are dynamically created or generated beforehand.

Animation generation module 232 may generate an animation through a rendering processes performed in web browsers or mobile apps. Animation generation module 232 may also perform tweening operations to dynamically create animations based on real-time interaction with the 3D virtual object. Other forms of animation generation may be performed based on the viewpoint of the user, depth of the object, a determination, from the animation detection module 231, as to which animation is to be displayed.

Web tag module 233 may take one or more 3D virtual objects and the animations that are associated with them and output them into standard web tags that can be use on any advertising platform that supports standard HTML5. The web tag may be ad tags, third-party-tags, or 3PAS. Web tags may be snippet of HTML5 code that a user may copy-and-paste into any ad platform that support HTML5.

A web API may be provided to allow developers to implement custom logic and user experiences using JavaScript or other scripting languages, as well as non-scripted languages. Developers may also add custom designs and web elements using HTML5.

3D display generation module 240 may combine 3D virtual objects with video captured by camera 203 to create an AR environment. The overlay generated by the 3D image overlay module 224 may be rendered over the captured video and then displayed to the user through display module 205.

Alternatively, 3D display generation module 240 may receive 3D virtual objects from application 230, including animations associated with the 3D virtual objects and web tags that define the 3D virtual objects and animations. 3D display generation module 240 may then render, on the display, an interactive 360 degree advertisement which includes the one or more 3D virtual objects, their animations, as well as 2D or 3D background images and text.

FIG. 3 shows an example of an online display advertising banner 300 with 3D objects in accordance with aspects of the present disclosure. The example shown includes a background 310, a company logo 320 (e.g. BRAND logo), a quote button 330, an advertisement text 340, a 3D animation 350, an interaction instruction text 360 (e.g. “Drag to explore in 3D”) and an interaction instruction symbol 370 (e.g. symbol of the hand with finger pointing up).

Background 310 may be any image, including 2D and 3D images, composites of multiple images or layered images. Background 310 may also be dynamically generated, or predetermined texture or pattern.

Company logo 320 (e.g. BRAND logo) may be any company logo or product campaign logo. The company logo 320 may be any definable image or object that represents the company or product.

Quote button 330 is an object that a user may have simple interactions with. It may be a 3D object, 2D object, or a point of interest. The simple interactions may include submitting form data, following a link or displaying annotations and additional information. Quote button 330 may also prompt the user to enter additional information or preform other actions.

Advertisement text 340 may be displayed, animated, or modified in a predefined way or interactively. Advertisement text 340 may also be static 2D or 3D text.

3D animation 350 may be an animated humanoid character. The character may be animated performing default movements and actions, such as skating, dancing, waving and walking. User's may interact with the character causing the character to respond. The character can be manipulated by the user, causing the character to be rotated, scaled, zoomed, bent, squashed, stretched, dilated or any other kind of transformation. The character may respond to user interaction by mimicking human emotion, facial expressions, or body language.

Interaction instruction text 360 (e.g. “Drag to explore in 3D”) may give a simple explanation of possible interactions a user may perform. The interaction instruction text 360 may also be interacted with to display a more detailed list of possible interactions that can be performed and their responses.

Interaction instruction symbol 370 (e.g. symbol of the hand with finger pointing up) may be a visual representation of the interactions that the user may perform.

In this example, the 3D animation 350 can be an animation of a human oriented in a standing position. 3D animation 350 may be rotated in 360 degrees about a vertical axis of the 3D animation 350 such that when a user swipes or drags the user's finger across the display on the webpage or mobile application of the advertising banner 300, from left to right, or right to left, the 3D animation 350 can rotate about the vertical axis of the 3D animation 350 of the advertising banner 300. In this example, the instruction text 360 and instruction symbol 370 can relate to the 360 degrees rotation of the 3D animation 350.

In other examples, different interactions and manipulations to the client device 100, webpage or application, advertising banner, or a combination thereof, can result in different interactions with the 3D animation 350. For example, a swipe of the screen where the 3D animation 350 is located can result in the 3D animation rotating about its horizontal axis. Depending on the interaction, the 3D animation 350 can be manipulated by the user, causing the character to be rotated, scaled, zoomed, bent, squashed, stretched, dilated or any other kind of transformation.

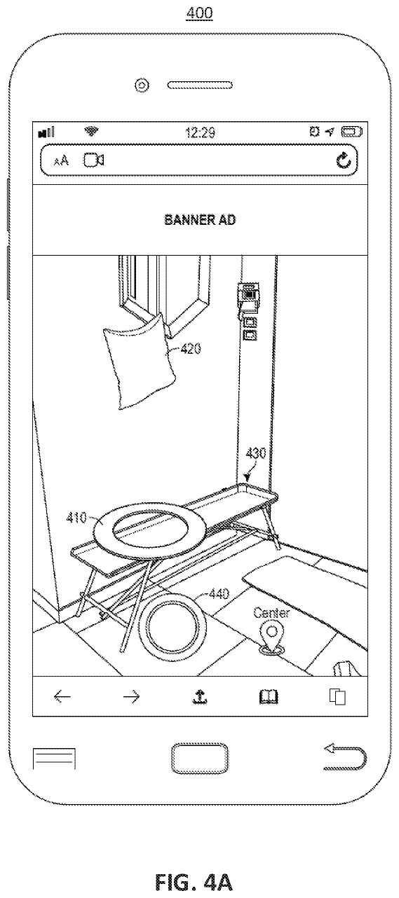

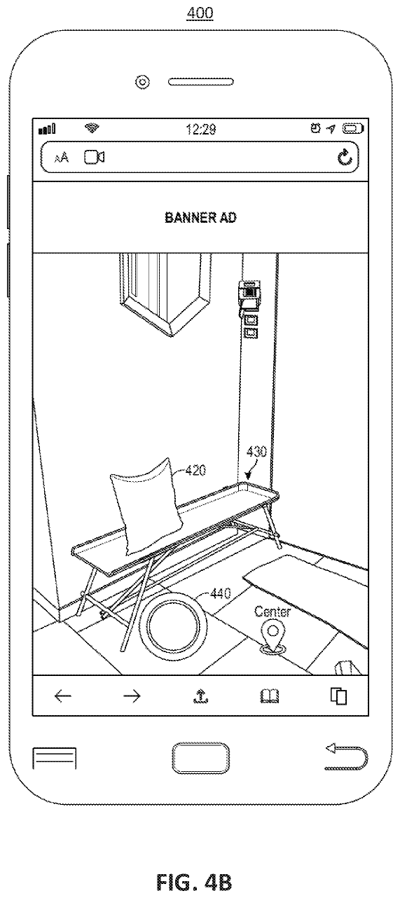

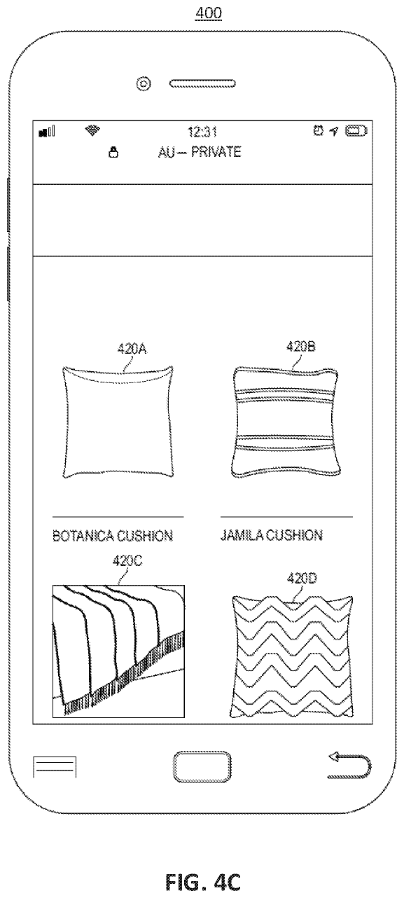

FIGS. 4A-4B shows an example of an AR environment 400 with a 3D object in accordance with aspects of the present disclosure. The example shown includes the environment 400, a position indicator 410 (e.g. ring or ‘X’), a virtual object 420 (e.g. 3D object to be overlaid), a physical object 430 (e.g. bench, wall, door, furniture) and a shutter button 440.

The environment 400 may be an AR environment that displays video captured from camera 203. The environment 400 may be implemented in a webpage or mobile application.

Position indicator 410 may be any visual indication of a location or position selected by a user. The position indicator may be displayed at a default location before a user has initially interacted with the display, or not displayed until a user performs an interaction. The user may touch and drag the position indicator 410 to a desired location of a virtual object 420. The user may also perform a touch, tap, double tap or any other selection gesture, to select a location in which to place a virtual object 420. The position indicator 410 may be in the form of a colored circle, ‘X’, cross, or predefined/default object. The position indicator 410 may itself be animated. The position indicator 410 may be manipulated by adjusting the scale or size, orientation, rotation and position. This manipulation may adjust the exact position and orientation of the virtual object 420 before it has been selected.

Virtual object 420 (e.g. 3D object to be overlaid) may be any object a user wishes to place in the environment 400. For example, virtual object 420 may be a pillow, as shown in FIGS. 4A-4B. Virtual object 420 may be placed at the position indicator 410. A user may manipulate the virtual object 420 by performing predefined gestures. A user may modify the shape, color, texture, type and model of object that is displayed as virtual object 420.

Physical object 430 (e.g. bench, wall, door, furniture) may be any real world object. Physical object 430 may be defined by a position within the environment as well as its orientation. Physical object 430 may have one or more surfaces in which virtual object 420 may be placed in contact with. Physical object 430 may be mapped along with the entirety of the AR environment to generate a 3D model. The 3D model may be used in the placement of virtual object 420.

Shutter button 440 may be used to take a snapshot of the current environment being displayed on the screen. The shutter button may also be used to navigate to a different menu, such as virtual object selection interface 450. The shutter button 440 may be used as an input to trigger a dropping or placement of the virtual object 420.

FIG. 4C shows an example of a virtual object selection interface 450 in accordance with aspects of the present disclosure. The example shown includes the virtual object selection interface 450 and virtual objects 420A-420D. In this example, the virtual object selection interface 450 can include a webpage or application page for an online catalog wherein the catalog lists a plurality of selectable items related to the virtual object 420 in the AR and can be displayed by a click-through link of text related to the AR environment. In another example, the user can select a different item from that of the virtual object 420 in the online catalog and the client device, application, or webpage, can display the AR environment with the newly selected item as the new virtual object. For example, the user can select virtual object 420B, and the virtual object selection interface 450 can revert back to environment 400 and display an interactive virtual object 420B.

Virtual object selection interface 450 may display one or more virtual objects 420A-420D for selection by a user. The user may scroll or navigate the virtual object selection interface 450 in the same way as a catalog of products.

Virtual objects 420A-420D may be variations of a type, model, or category of objects. For example, virtual objects 420A-420D may be different pillows as shown in FIG. 4C.

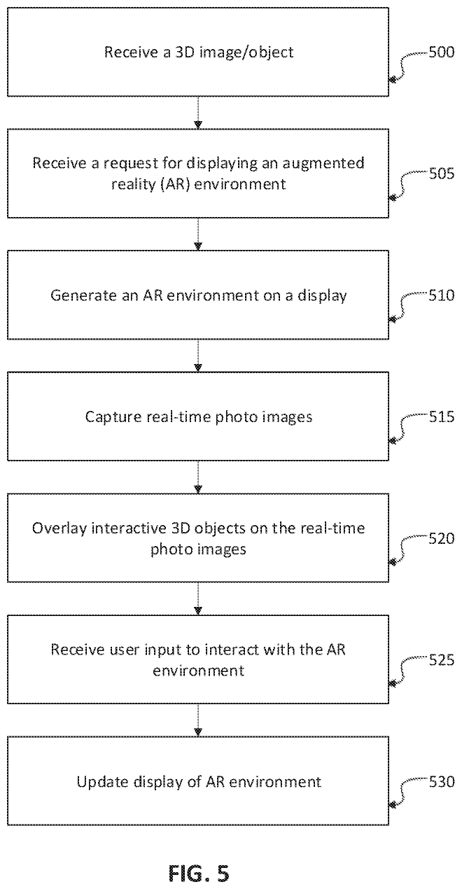

FIG. 5 shows an example of an overview of a process for generating an AR environment in accordance with aspects of the present disclosure. In some examples, these operations may be performed by a system including a processor executing a set of codes to control functional elements of an apparatus. Additionally, or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 500, a 3D image or object is received. The 3D image can include a plurality of pixels forming a 3D object. The 3D object may be a 3D virtual object with associated animations. The 3D object may be used by AR module 220, or application 230, or both. The 3D image may be a virtual object as described above with respect to FIGS. 4A-4C. The 3D object may be a default object or an object selected by a user prior to the request to display an AR environment.

At step 505, a request for displaying an AR environment is received from a user. In some cases, the operations of this step may refer to, or be performed by, client device as described with reference to FIGS. 1 and 2. For example. user interaction with client device 100, such as selection of a mobile app or navigating to a webpage may cause the request to be sent to the AR module 220 to launch the AR environment.

At step 510, an AR environment is generated on a display. In some cases, the operations of this step may refer to, or be performed by, AR module 220 as described with reference to FIG. 2. The request may be received as a result of user interaction with a client device 100. The AR module 220 may map the environment, generate a 3D model of the environment, and orient the client device 100 with the environment.

At step 515, real-time photo images are captured. In some cases, the operations of this step may refer to, or be performed by, camera module 203 as described with reference to FIG. 2. For example, one or more cameras may be used to capture still images or videos of the environment. The images may be 2D, 2.5D, or 3D images. These captured images may then be used by the AR module update the 3D model of the environment or to composite the AR images.

At step 520, interactive 3D objects are overlayed on the real-time photo images. In some cases, the operations of this step may refer to, or be performed by, 3D image overlay module 224 as described with reference to FIG. 2. The interactive 3D objects may be positioned, scaled/sized and orientated by the 3D image overlay module with relation to the 3D model of the environment prior to being rendered. The 3D display generation module 240 may then composite and overlay the interactive 3D image onto the captured images/videos. In one example, the real time photo images of the AR environment includes a real world physical environment such that the one or more interactive 3D objects are virtually projected onto the real world physical environment. In one example, the real time photo images of the AR environment includes a self portrait environment of the user such that the one or more interactive 3D objects are virtually projected onto a physical member of the user.

At step 525, user input to interact with the AR environment is received. In some cases, the operations of this step may refer to, or be performed by, gesture detection module 223 as described with reference to FIG. 2. For example, a user may perform touch gestures, hand gestures, facial gestures, body gestures, eye gestures, and gestures of the client device 100 itself. These gestures may be used to manipulate or interact with the 3D objects in the AR environment. Camera module 203, gyroscope 221 and accelerometer 222, may be used individually or in combination to detect user gestures. The commands associated with the gestures may then performed and the 3D objects appearance may be modified. In one example, the user can manipulate or interact with the 3D objects by rotating, scaling and rescaling, moving, orienting and reorienting, changing or swapping out a selected interactive 3D object from the one or more interactive 3D objects, changing a view or perspective of the one or more interactive 3D objects, or a combination thereof. In one example, the manipulation of the one or more interactive 3D objects can be performed by using a web page browser configured to display the AR environment. In one example, the manipulation of the one or more interactive 3D objects on a web page browser can be performed by web page functions comprising scrolling gestures, click-and-drag gestures, mouse cursor movement, or a combination thereof. In one example, the manipulation of the one or more interactive 3D objects can be performed by using a web browser or mobile application on a mobile device. In one example, the manipulation of the one or more interactive 3D objects on a web page browser or mobile application on a mobile device can be performed by moving, rotating, tilting, orienting, or a combination thereof, of the mobile device.

At step 530, display of AR environment is updated. In some cases, the operations of this step may refer to, or be performed by, 3D display generation module 240 as described with reference to FIG. 2. The AR environment may be updated in real time. In one example, a destination page request can be detected, and the display device can be updated to display the destination page on a web browser or mobile application.

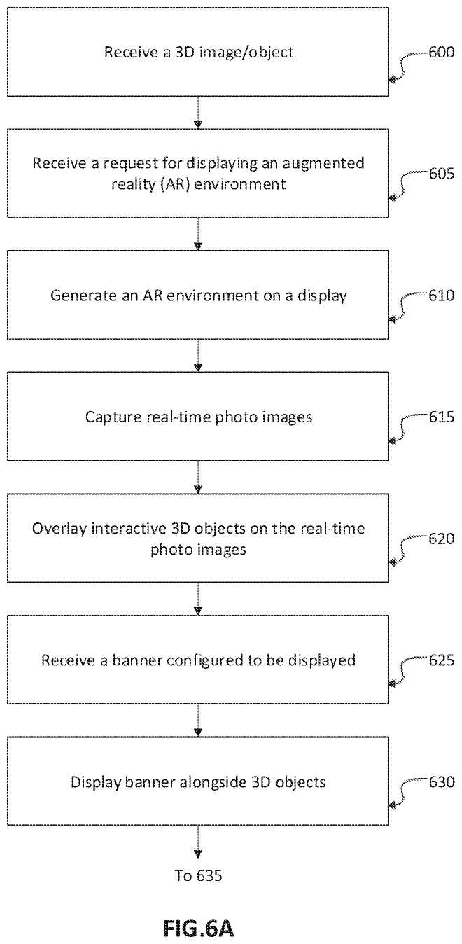

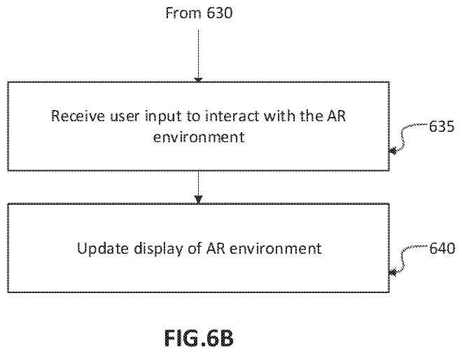

FIGS. 6A-6B shows an example of an overview of a process for displaying interactive 3D object on a banner in an AR environment in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 600, a 3D image or object is received. The 3D object may be a 3D virtual object with associated animations. The 3D object may be used by AR module 220, or application 230, or both. The 3D image may be a virtual object as described above with respect to FIGS. 4A-4C. The 3D object may be a default object or an object selected by a user prior to the request to display an AR environment. In one example, a plurality of 3D images, each including one or more 3D objects or interactive 3D objects are received.

At step 605, a request for displaying an AR environment is received from a user. In some cases, the operations of this step may refer to, or be performed by, client device as described with reference to FIGS. 1 and 2. For example. user interaction with client device 100, such as selection of a mobile app or navigating to a webpage may cause the request to be sent to the AR module 220 to launch the AR environment.

At step 610, an AR environment is generated on a display. In some cases, the operations of this step may refer to, or be performed by, AR module 220 as described with reference to FIG. 2. The request may be received as a result of user interaction with a client device 100. The AR module 220 may map the environment, generate a 3D model of the environment, and orient the client device 100 with the environment.

At step 615, real-time photo images are captured. In some cases, the operations of this step may refer to, or be performed by, camera module 203 as described with reference to FIG. 2. For example, one or more cameras may be used to capture still images or videos of the environment. The images may be 2D, 2.5D, or 3D images. These captured images may then be used by the AR module update the 3D model of the environment or to composite the AR images.

At step 620, one or more interactive 3D objects are overlayed on the real-time photo images. In some cases, the operations of this step may refer to, or be performed by, 3D image overlay module 224 as described with reference to FIG. 2. The interactive 3D objects may be positioned, scaled or sized and orientated by the 3D image overlay module with relation to the 3D model of the environment prior to being rendered. The 3D display generation module 240 may then composite and overlay the interactive 3D image onto the captured images/videos.

At step 625, a banner configured to be displayed is received. In some cases, the operations of this step may refer to, or be performed by, application 230 as described with reference to FIG. 2. The banner may include 3D objects with associated animations. The banner may also include 2D or 3D background images, text, buttons, input fiends, annotations, instruction and symbols.

At step 630, the banner is displayed alongside 3D objects. In some cases, the operations of this step may refer to, or be performed by, 3D display generation module 240 as described with reference to FIG. 2. The banner and 3D images may be composited and overlayed on the captured video or photos. In one example, the banner can include one or more lines of text, one or more logos, one or more two dimensional (2D) images, one or more 2D graphics, one or more 2D animations, a background image, or a combination thereof.

At step 635, user input to interact with the AR environment is received. In some cases, the operations of this step may refer to, or be performed by, gesture detection module 223 as described with reference to FIG. 2. For example, a user may perform touch gestures, hand gestures, facial gestures, body gestures, eye gestures, and gestures of the client device 100 itself. These gestures may be used to manipulate or interact with the 3D objects in the AR environment. Camera module 203, gyroscope 221 and accelerometer 222, may be used individually or in combination to detect user gestures. The commands associated with the gestures may then performed and the 3D objects appearance may be modified.

At step 640, display of AR environment is updated. In some cases, the operations of this step may refer to, or be performed by, 3D display generation module 240 as described with reference to FIG. 2. The AR environment may be updated in real time.

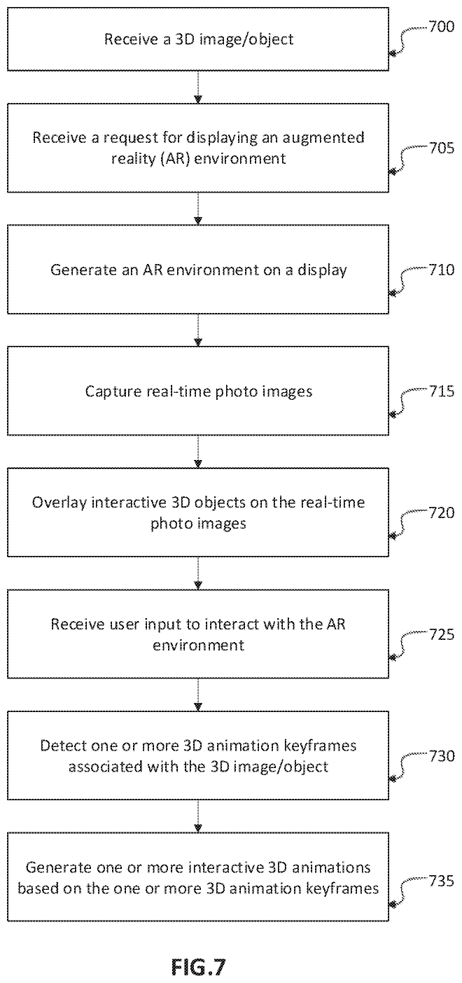

FIG. 7 shows an example of an overview of a process for displaying interactive 3D animations in an AR environment in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 700, a 3D image or object is received. The 3D object may be a 3D virtual object with associated animations. The 3D object may be used by AR module 220, or application 230, or both. The 3D image may be a virtual object as described above with respect to FIGS. 4A-4C. The 3D object may be a default object or an object selected by a user prior to the request to display an AR environment.

At step 705, a request for displaying an AR environment is received from a user. In some cases, the operations of this step may refer to, or be performed by, client device as described with reference to FIGS. 1 and 2. For example. user interaction with client device 100, such as selection of a mobile app or navigating to a webpage may cause the request to be sent to the AR module 220 to launch the AR environment.

At step 710, an AR environment is generated on a display. In some cases, the operations of this step may refer to, or be performed by, AR module 220 as described with reference to FIG. 2. The request may be received as a result of user interaction with a client device 100. The AR module 220 may map the environment, generate a 3D model of the environment, and orient the client device 100 with the environment.

At step 715, real-time photo images are captured. In some cases, the operations of this step may refer to, or be performed by, camera module 203 as described with reference to FIG. 2. For example, one or more cameras may be used to capture still images or videos of the environment. The images may be 2D, 2.5D, or 3D images. These captured images may then be used by the AR module update the 3D model of the environment or to composite the AR images.

At step 720, interactive 3D objects are overlayed on the real-time photo images. In some cases, the operations of this step may refer to, or be performed by, 3D image overlay module 224 as described with reference to FIG. 2. The interactive 3D objects may be positioned, scaled/sized and orientated by the 3D image overlay module with relation to the 3D model of the environment prior to being rendered. The 3D display generation module 240 may then composite and overlay the interactive 3D image onto the captured images/videos.

At step 725, user input to interact with the AR environment is received. In some cases, the operations of this step may refer to, or be performed by, gesture detection module 223 as described with reference to FIG. 2. For example, a user may perform touch gestures, hand gestures, facial gestures, body gestures, eye gestures, and gestures of the client device 100 itself. These gestures may be used to manipulate or interact with the 3D objects in the AR environment. Camera module 203, gyroscope 221 and accelerometer 222, may be used individually or in combination to detect user gestures. The commands associated with the gestures may then performed and the 3D objects appearance may be modified.

At step 730, one or more 3D animation keyframes associated with the 3D image/object are detected. In some cases, the operations of this step may refer to, or be performed by, animation detection module 231 as described with reference to FIG. 2. Upon receiving user interaction with a 3D object, animation detection module 231 may determine which animation is associated with the specific interaction. This determination may then be passed to the animation generation module 232.

At step 735, one or more interactive 3D animations based on the one or more 3D animation keyframes is generated. In some cases, the operations of this step may refer to, or be performed by, animation generation module 232 as described with reference to FIG. 2. The animation determination received from step 730 may then be used to instruct the animation generation module 232 on the type of animation to be generated. The generation of the animation may be simulation based, tweening based, or any other form of animation generation.

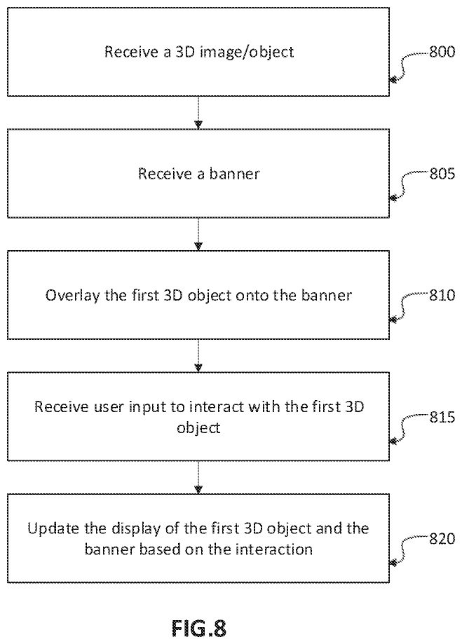

FIG. 8 shows an example of an overview of a process for displaying and interacting with an interactive 3D banner in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 800, a 3D image or object is received. The 3D object may be a 3D virtual object with associated animations. The 3D object may be used by AR module 220, or application 230, or both. The 3D image may be a virtual object as described above with respect to FIGS. 4A-4C. The 3D object may be a default object or an object selected by a user prior to the request to display an AR environment.

At step 805, a banner is received. In some cases, the operations of this step may refer to, or be performed by, application 230 as described with reference to FIG. 2. The banner may include 3D objects with associated animations. The banner may also include 2D or 3D background images, text, buttons, input fiends, annotations, instruction and symbols.

At step 810, the first 3D object is overlayed on the banner. In some cases, the operations of this step may refer to, or be performed by, 3D image overlay module 224 and the 3D display generation module 240 as described with reference to FIG. 2. The interactive 3D object may be positioned, scaled/sized and orientated by the 3D image overlay module with relation to the background, text, buttons, input fiends, annotations, instruction and symbols prior to being rendered. The 3D display generation module 240 may then composite and overlay the interactive 3D object with the received banner.

At step 815, user input to interact with the first 3D object is received. In some cases, the operations of this step may refer to, or be performed by, gesture detection module 223 as described with reference to FIG. 2. For example, a user may perform touch gestures, hand gestures, facial gestures, body gestures, eye gestures, and gestures or movements of the client device 100 itself. These gestures may be used to manipulate or interact with the 3D object. Camera module 203, gyroscope 221 and accelerometer 222, may be used individually or in combination to detect user gestures. The commands associated with the gestures may then performed and the 3D objects appearance may be modified.

At step 820, display of the first 3D object and the banner is updated. In some cases, the operations of this step may refer to, or be performed by, 3D display generation module 240 as described with reference to FIG. 2. The first 3D object and the banner may be updated in real time.

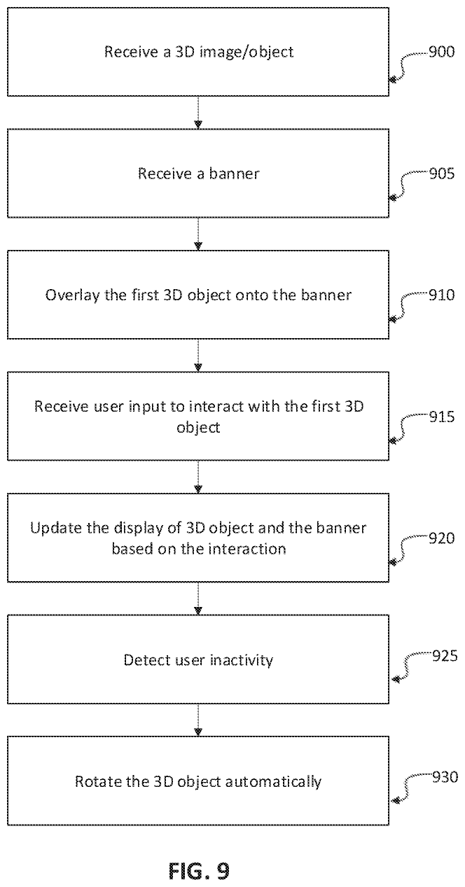

FIG. 9 shows an example of an overview of a process for displaying and interacting with an interactive 3D banner in an AR environment in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 900, a 3D image or object is received. The 3D object may be a 3D virtual object with associated animations. The 3D object may be used by AR module 220, or application 230, or both. The 3D image may be a virtual object as described above with respect to FIGS. 4A-4C. The 3D object may be a default object or an object selected by a user prior to the request to display an AR environment.

At step 905, a banner is received. In some cases, the operations of this step may refer to, or be performed by, application 230 as described with reference to FIG. 2. The banner may include 3D objects with associated animations. The banner may also include 2D or 3D background images, text, buttons, input fiends, annotations, instruction and symbols.

At step 910, the first 3D object is overlayed on the banner. In some cases, the operations of this step may refer to, or be performed by, 3D image overlay module 224 and the 3D display generation module 240 as described with reference to FIG. 2. The interactive 3D object may be positioned, scaled/sized and orientated by the 3D image overlay module with relation to the background, text, buttons, input fiends, annotations, instruction and symbols prior to being rendered. The 3D display generation module 240 may then composite and overlay the interactive 3D object with the received banner.

At step 915, user input to interact with the first 3D object is received. In some cases, the operations of this step may refer to, or be performed by, gesture detection module 223 as described with reference to FIG. 2. For example, a user may perform touch gestures, hand gestures, facial gestures, body gestures, eye gestures, and gestures of the client device 100 itself. These gestures may be used to manipulate or interact with the 3D object. Camera module 203, gyroscope 221 and accelerometer 222, may be used individually or in combination to detect user gestures. The commands associated with the gestures may then performed and the 3D objects appearance may be modified. For example, the 3D objects can be selectable and rotatable. In one example, the 3D object can be rotated about a vertical axis, a horizontal axis, or a combination thereof

At step 920, display of the first 3D object and the banner is updated. In some cases, the operations of this step may refer to, or be performed by, 3D display generation module 240 as described with reference to FIG. 2. The first 3D object and the banner may be updated in real time. For example, the client device can detect a selection of the interactive 3D object, and display a destination page based on the selection.

At step 925, user inactivity is detected. In some cases, the operations of this step may refer to, or be performed by, gesture detection module 223 as described with reference to FIG. 2. In the event that the gesture detection module 223 does not detect any gestures within a predetermined span of time, the gesture detection module 223 may determine that a user is inactive. The inactivity determination may then be transmitted to the animation generation module 232.

At step 930, the 3D object is automatically rotated. In some cases, the operations of this step may refer to, or be performed by, animation generation module 232 as described with reference to FIG. 2. The animation generation module 232 may animate the 3D object in a rotating manner as a result of the inactivity determination. The rate of rotation may be constant or may increase based on the duration of the user's inactivity. In one example, the 3D object can be rotated automatically by a web browser application or mobile application upon detecting a user inactivity reaching a specified threshold.

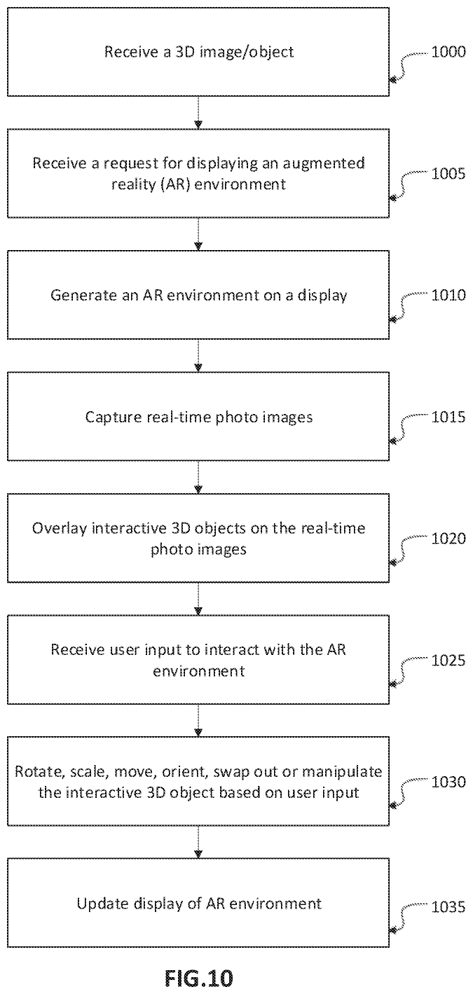

FIG. 10 shows an example of an overview of a process for displaying the user manipulations of an interactive 3D object in an AR environment in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 1000, a 3D image or object is received. The 3D object may be a 3D virtual object with associated animations. The 3D object may be used by AR module 220, or application 230, or both. The 3D image may be a virtual object as described above with respect to FIGS. 4A-4C. The 3D object may be a default object or an object selected by a user prior to the request to display an AR environment.

At step 1005, a request for displaying an AR environment is received from a user. In some cases, the operations of this step may refer to, or be performed by, client device as described with reference to FIGS. 1 and 2. For example. user interaction with client device 100, such as selection of a mobile app or navigating to a webpage may cause the request to be sent to the AR module 220 to launch the AR environment.

At step 1010, an AR environment is generated on a display. In some cases, the operations of this step may refer to, or be performed by, AR module 220 as described with reference to FIG. 2. The request may be received as a result of user interaction with a client device 100. The AR module 220 may map the environment, generate a 3D model of the environment, and orient the client device 100 with the environment.

At step 1015, real-time photo images are captured. In some cases, the operations of this step may refer to, or be performed by, camera module 203 as described with reference to FIG. 2. For example, one or more cameras may be used to capture still images or videos of the environment. The images may be 2D, 2.5D, or 3D images. These captured images may then be used by the AR module update the 3D model of the environment or to composite the AR images.

At step 1020, interactive 3D objects are overlayed on the real-time photo images. In some cases, the operations of this step may refer to, or be performed by, 3D image overlay module 224 as described with reference to FIG. 2. The interactive 3D objects may be positioned, scaled/sized and orientated by the 3D image overlay module with relation to the 3D model of the environment prior to being rendered. The 3D display generation module 240 may then composite and overlay the interactive 3D image onto the captured images/videos.

At step 1025, user input to interact with the AR environment is received. In some cases, the operations of this step may refer to, or be performed by, gesture detection module 223 as described with reference to FIG. 2. For example, a user may perform touch gestures, hand gestures, facial gestures, body gestures, eye gestures, and gestures of the client device 100 itself. These gestures may be used to manipulate or interact with the 3D objects in the AR environment. Camera module 203, gyroscope 221 and accelerometer 222, may be used individually or in combination to detect user gestures. The commands associated with the gestures may then performed and the 3D objects appearance may be modified.

At step 1030, the interactive 3D object is rotated, scaled, moved, oriented, swapped out or manipulated based on user input. In some cases, the operations of this step may refer to, or be performed by, animation generation module 232 as described with reference to FIG. 2. The animation generation module 232 may animate the 3D object by causing rotation, scaling, moving, orienting, swapping out or manipulating the object as a result of the gesture detected by gesture detection module 223. The animations generated may be associated with one or more gestures.

At step 1035, display of AR environment is updated. In some cases, the operations of this step may refer to, or be performed by, 3D display generation module 240 as described with reference to FIG. 2. The AR environment may be updated in real time.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

In general, the terms “engine” and “module”, as used herein, refer to logic embodied in hardware or firmware, or to a collection of software instructions, possibly having entry and exit points, written in a programming language, such as, for example, Java, JavaScript, Lua, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, or may be invoked in response to detected events or interrupts, or a combination thereof. Software modules configured for execution on computing devices may be provided on one or more computer readable media, such as compact discs, digital video discs, flash drives, or any other tangible media. Such software code may be stored, partially or fully, on a memory device of the executing computing device. Software instructions may be embedded in firmware, such as an EPROM. It will be further appreciated that hardware modules may be comprised of connected logic units, such as gates and flip-flops, may be comprised of programmable units, such as programmable gate arrays or processors, or a combination thereof. The modules described herein are preferably implemented as software modules, but may be represented in hardware or firmware. Generally, the modules described herein refer to logical modules that may be combined with other modules or divided into sub-modules despite their physical organization or storage

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A computer-implemented method for displaying a three dimensional (3D) image, the method comprising:
receiving a 3D image, the 3D image comprising a plurality of pixels forming a first 3D object;
receiving a request for displaying an augmented reality (AR) environment; and
generating an AR environment on a display, the AR environment comprising:
real time photo images received by an image capture device;
one or more interactive 3D objects, including the first 3D object, overlayed on the photo images, wherein the one or more interactive 3D objects can be manipulated by a user engaging in with the AR environment.

2. The computer-implemented method of claim 1, further comprising receiving a banner configured to be displayed on a display device alongside the one or more interactive 3D objects.

3. The computer-implemented method of claim 2, wherein the banner comprises one or more lines of text, one or more logos, one or more two dimensional (2D) images, one or more 2D graphics, one or more 2D animations, a background image, or a combination thereof.

4. The computer-implemented method of claim 1, wherein the interactive 3D object is an animated 3D object.

5. The computer-implemented method of claim 1, further comprising
detecting one or more 3D animation keyframes associated with the 3D image;
generating one or more interactive 3D animations based on the one or more 3D animation keyframes.

6. The computer-implemented method of claim 1, further comprising receiving a plurality of 3D images, each comprising one or more 3D objects.

7. The computer-implemented method of claim 1, further comprising creating a web tag, ad tag, third party tag, or third party ad serving (3PAS), associated with the 3D image.

8. The computer-implemented method of claim 1, wherein the one or more interactive 3D objects can be manipulated by rotating, scaling and rescaling, moving, orienting and reorienting, changing or swapping out a selected interactive 3D object from the one or more interactive 3D objects, changing a view or perspective of the one or more interactive 3D objects, or a combination thereof.

9. The computer-implemented method of claim 1, wherein the manipulation of the one or more interactive 3D objects can be performed by using a web page browser configured to display the AR environment.

10. The computer-implemented method of claim 9, wherein the manipulation of the one or more interactive 3D objects on a web page browser can be performed by web page functions comprising scrolling gestures, click-and-drag gestures, mouse cursor movement, or a combination thereof.

11. The computer-implemented method of claim 1 wherein the manipulation of the one or more interactive 3D objects can be performed by using a web browser or mobile application on a mobile device.

12. The computer-implemented method of claim 11, wherein the manipulation of the one or more interactive 3D objects on a web page browser or mobile application on a mobile device can be performed by moving, rotating, tilting, orienting, or a combination thereof, of the mobile device.

13. The computer-implemented method of claim 1, wherein the real time photo images of the AR environment includes a real world physical environment such that the one or more interactive 3D objects are virtually projected onto the real world physical environment.

14. The computer-implemented method of claim 1, wherein the real time photo images of the AR environment includes a self portrait environment of the user such that the one or more interactive 3D objects are virtually projected onto a physical member of the user.

15. The computer-implemented method of claim 1, further comprising:
detecting a request for viewing a destination page; and
displaying the destination page on a web browser or mobile application.

16. A computer-implemented method for displaying a three dimensional (3D) image, the method comprising:
receiving a 3D image, the 3D image comprising a plurality of pixels forming a first 3D object;
receiving a banner;
overlaying the first 3D object onto the banner, wherein the first 3D object is an interactive 3D object.

17. The computer-implemented method of claim 16, wherein the interactive 3D object is selectable and rotatable.

18. The computer-implemented method of claim 17, further comprising detecting a selection of the interactive 3D object, and displaying a destination page based on the selection.

19. The computer-implemented method of claim 16, wherein the interactive 3D object can be rotated about a vertical axis, a horizontal axis, or a combination thereof.

20. The computer-implemented method of claim 16, wherein the interactive 3D object can be rotated automatically by a web browser application or mobile application upon detecting a user inactivity reaching a specified threshold.

21. The computer-implemented method of claim 16, wherein the banner comprising one or more lines of text, one or more logos, one or more two dimensional (2D) images, one or more 2D graphics, one or more 2D animations, a background image, or a combination thereof.
